(19) United States
(12) Patent Application Publication
(10) Pub. No.: US 2026/0099693 A1
(43) Pub. Date: Apr. 9, 2026

(54) CONTENT QUALITY EVALUATION FOR RETRIEVAL AUGMENTED GENERATION (RAG) SYSTEMS

(71) Applicant: Microsoft Technology Licensing, LLC, Redmond, WA (US)

(72) Inventors: Haiyuan CAO, Snoqualmie, WA (US); Satarupa GUHA, Redmond, WA (US); Zeqi LIN, Beijing (CN); Fuhui FANG, Bellevue, WA (US); Atabak ASHFAQ, Vancouver (CA); Yu HU, Sammamish, WA (US)

(21) Appl. No.: 18/910,875

(22) Filed: Oct. 9, 2024

(51) Int. Cl. G06N 3/006; G06N 3/0475

(52) U.S. Cl. CPC G06N 3/006; G06N 3/0475

(57) ABSTRACT

A method for objectively evaluating content output by a retrieval augmented generation (RAG) system includes obtaining question-answer information for one or more data chunks residing in a source index and prompting a large language model (LLM) to generate one or more answer construct conditions for a first test question included in the question-answer information. Each of the answer construct conditions identifies a condition that is satisfied by a ground truth answer to the first test question. The method further includes generating a question-specific evaluation metric for the first test question based on the answer construct conditions and prompting multiple differently configured retrieval augmented generation (RAG) systems to answer the first test question based on information within the source index. The method additionally includes evaluating multiple answers to the first test question generated by the multiple RAG systems by repeatedly assessing the question-specific evaluation metric and presenting, on a user interface, comparative quality data quantifying a relative quality of the multiple responses generated by the multiple RAG systems.

### BACKGROUND

Retrieval augmented generation (RAG) assistants are sometimes employed as an intermediary between a large language model (LLM). The primary function of the RAG assistant is to translate a received user query into an LLM prompt that includes relevant additional contextual information that can help the LLM to answer the user query better. This additional contextual information can be helpful in several scenarios, such as when the user query relates to information that is external to the training dataset of the LLM, information that is incompletely described within the LLM training dataset, or in scenarios where the user desires a precise response that includes citations to source documents.

Users configure and interact with RAG assistants to support diverse computing needs across different disciplines. Frequently, end users self-provide source documents that are placed in the source index that is accessed and searched by the RAG assistant. For example, a user employing the RAG assistant as a tool to aid in software programming may provide a corpus of texts pertaining to libraries accessible in various programming languages, and the RAG assistant can then access and draw information from those documents to help an LLM answer queries related to programming questions. This corpus of texts is referred to herein as the “source index”of the RAG assistant.

In addition to providing the source documents to populate the source index, the end user of the RAG assistant may self-configure various system parameters of the RAG assistant and of the underlying LLM that the RAG assistant communicates with. In some cases, the user can also configure the LLM's identity, such as by selecting between multiple publicly-available natural language processing models. The selection of the LLM model identity, LLM input parameters, and RAG assistant parameters collectively contribute in complex ways to how accurately and completely the RAG system can respond to each user question. Varying these RAG system parameters can cause an RAG system to output answers of different quality when answering the same question using the same source index.

Current methods of assessing RAG system performance are highly subjective and entail significant human-led trial and error, which wastes user time. For instance, the end user may test a RAG system by providing the system with a set of questions pertaining to subject matter documented in the source index, observing answers generated by the RAG system, changing RAG configuration settings, and repeating the test with the same questions to see if the answers generated by the RAG system improve or worsen in response to each configuration change. This methodology is highly inefficient and subjective to the user's perception of “better” or “worse” answers. This methodology depends highly upon the user's expertise concerning the types of questions that the user would like the RAG system to be able to answer competently.

### SUMMARY

In some aspects, the techniques described herein related to systems and methods for objectively evaluating the quality of content generated by retrieval augmented generation (RAG) systems. A method disclosed herein includes obtaining question-answer information for a data chunk residing in a source index and prompting a large language model (LLM) to generate one or more answer construct conditions for a first test question included in the question-answer information. Each of the one or more answer construct conditions identifies a condition that is satisfied by a ground truth answer to the first test question. The method further includes generating a question-specific evaluation metric for the first test question based on the answer construct conditions and prompting multiple differently configured retrieval augmented generation (RAG) systems to answer the first test question based on information within the source index. The method further includes evaluating multiple answers to the first test question generated by the multiple RAG systems by repeatedly assessing the question-specific evaluation metric and presenting, on a user interface, comparative quality data quantifying the quality of the multiple responses generated by the multiple RAG systems relative to one another.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example RAG-generated content evaluation system that incorporates aspects of the herein-disclosed technology

FIG. 2 illustrates further aspects of an example RAG-generated content evaluation system.

FIG. 3 illustrates additional aspects of an example RAG-generated content evaluation system.

FIG. 4 illustrates an example user interface presented by a RAG-generated content evaluation system implementing the herein-disclosed technology.

FIG. 5 illustrates example operations for conducting an objective quality assessment of content output by multiple, differently configured RAG systems

FIG. 6 illustrates an example computing device for use in implementing the described technology.

### DETAILED DESCRIPTIONS

The herein-disclosed technology provides a software tool that facilitates objective evaluation of content generated by RAG systems. According to one implementation, the software tool generates metrics for evaluating the quality of responses output by differently configured RAG systems. Each metric is automatically generated in reference to a test question, and a corresponding “ground truth answer” is derived from the text of a source document that resides in a source index accessed by a RAG system. Key components of each ground truth answer are automatically identified and used to define a question-specific evaluation metric that provides a framework for objectively quantifying the quality (e.g., accuracy and completeness) of any RAG answer to the corresponding test question. As used herein, the term “ground truth answer” refers to a correct answer to a question derived from the data chunk that was also used to derive the question.

When multiple, differently configured RAG systems that all utilize the same source index are asked the same set of test questions, the answers from the differently configured RAG systems can be evaluated using the above-described question-specific evaluation metrics to yield a set of scores that facilitate an objective response quality comparison across the differently configured RAG systems. This comparison, in turn, allows an end user to quickly and easily identify a specific set of RAG system parameters that yield the best RAG performance with respect to each end user's unique use scenario and source index.

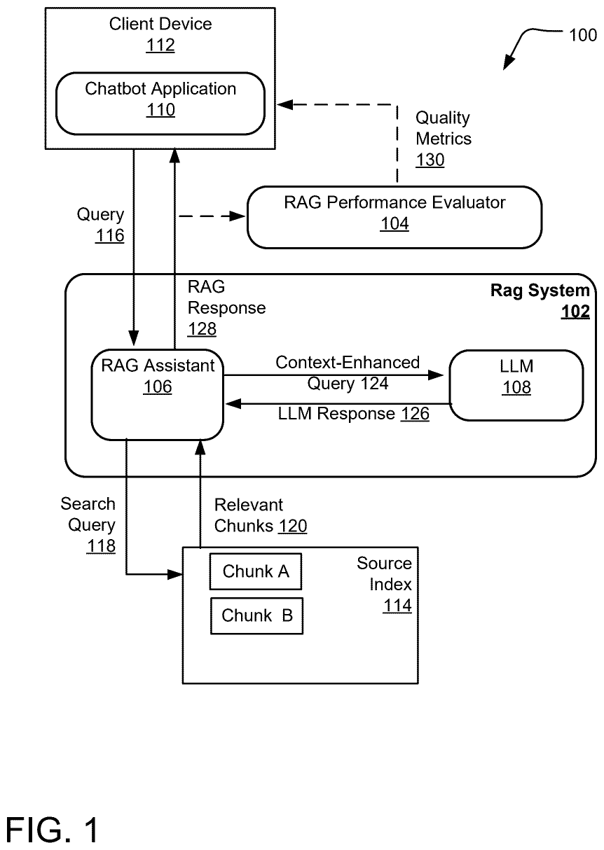

FIG. 1 illustrates an example RAG-generated content evaluation system 100 that incorporates aspects of the herein disclosed technology. The RAG-generated content evaluation system 100 includes a RAG performance evaluator 104 that objectively evaluates content generated by a RAG system 102. In implementations of the technology, the RAG performance evaluator 104 provides comparative metrics that characterize and quantify the performance of RAG system 102 in contrast to one or more differently-configured RAG systems. In FIG. 1, the RAG system 102 is shown in isolation (without reference to other RAG systems) to help demonstrate the underlying functionality of the RAG system that is enhanced via the herein-disclosed technology.

The RAG system 102 is part of a chat platform that utilizes a RAG assistant 106 as an intermediary between a large language model (LLM) 108 and a chatbot application 110 that interacts with a user through a user interface of a client device 112. In response to receiving a query 116 from a user, the chatbot application 110 provides the user inputs (e.g., the query along with other recent conversation data) to the RAG assistant 106, as shown by arrow “A.” In response, the RAG assistant 106 vectorizes the user inputs and transmits a search query 118 to a source index 114 to identify stored data documents or portions of documents with corresponding vector representations that satisfy some degree of similarity with the vectorized user inputs. For example, the source index 114 is a file repository or database that includes a corpus of user-selected documents or portions of such documents. In some cases, the documents in the source index 114 pertain to a particular subject matter domain for which the user is primarily using the system. The source index 114 is shown to include various data chunks (e.g., Chunk A, Chunk B), which may, for example, represent documents, portions of documents, or even data derived from portions of documents (e.g., document summaries, translations).

In response to receiving the search query 118, the RAG assistant 106 performs vector analysis to identify data chunks residing in the source index 114 that are most similar to the user inputs and, therefore, assumed to be relevant to the query 116. These identified similar data chunks are returned, e.g., as “relevant chunks 120” to the RAG assistant 106. The number of data chunks returned depends upon a configurable parameter of the RAG assistant 106, as does the threshold for selection (e.g., the threshold dictating how similar a chunk must be to the user inputs to quality for selection as one of the relevant chunks 120). The RAG assistant 106 then generates a context-enhanced query 124 that is passed to the LLM 108. This enhanced query typically includes the query 116, the relevant chunks 120 (also referred to herein as “context data”), and a directive instructing the LLM 108 to utilize the context data to answer the user query. The LLM 108 responds to the context-enhanced query 124 with LLM response 126, which is conveyed back to the user as RAG response 128. In various implementations, the RAG response 128 is either verbatim identical to the LLM response 126 or modified somehow by the RAG assistant 106 (via re-formatting, addition of citations to source document(s)).

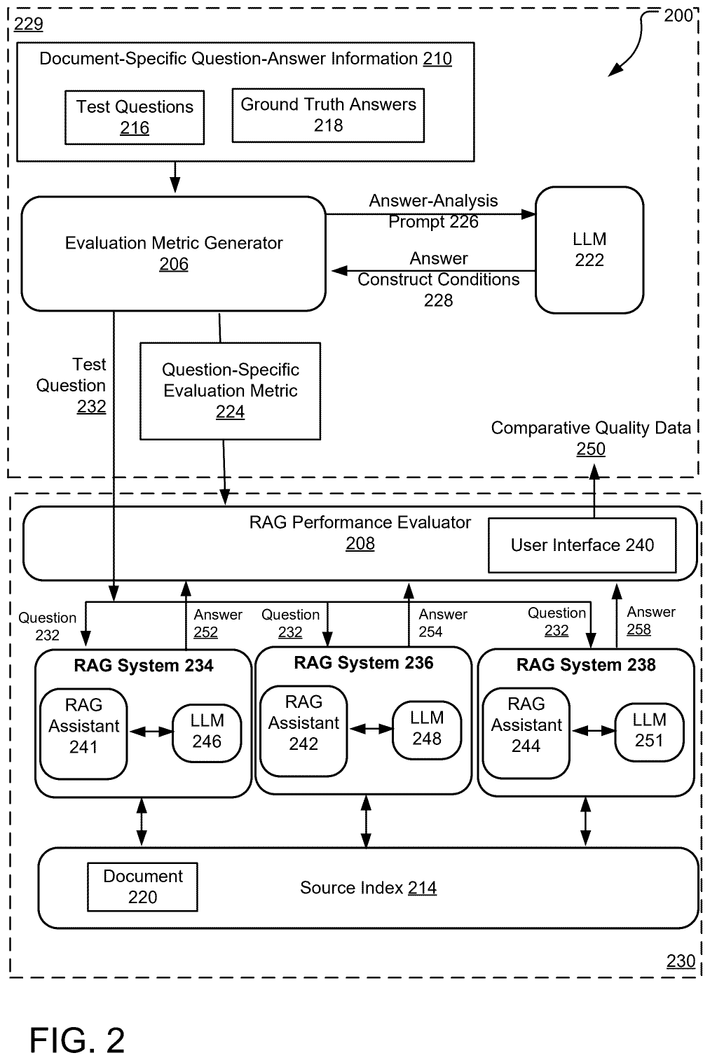

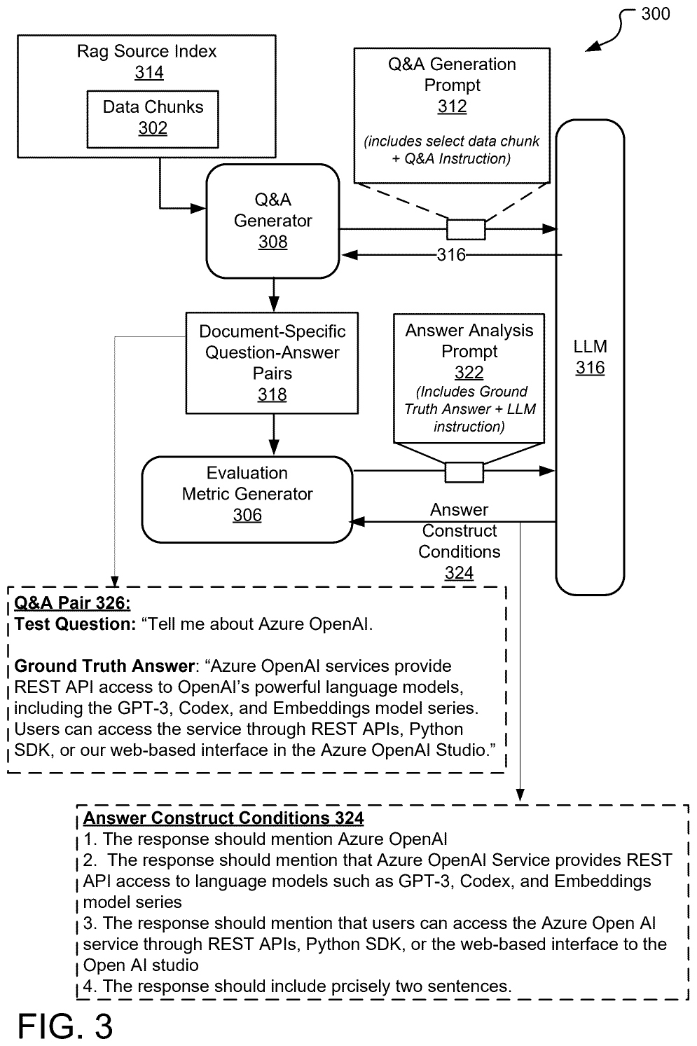

In FIG. 1, RAG response 128 is shown to be intercepted and evaluated by the RAG performance evaluator 104, which is discussed in further detail with respect to FIGS. 2-3. The RAG performance evaluator 104 processes the RAG response 128 to generate comparative quality metrics 130 indicative of its accuracy and completion with respect to query 116.

In one implementation, the comparative quality metrics 130 are generated for predefined “test questions” answerable by documents within the source index 114. The chatbot application 110 passes the test questions to the RAG system 102 during an initial configuration process designed to help the end user identify which unique set of RAG system parameters yields the highest quality answers to the set of test questions. The query 116 is, in this case, a question included in a predefined set of test questions, and the RAG performance evaluator 104 evaluates the RAG response 128 to the question using a question-specific quality metric described in greater detail with respect to FIG. 2-3 below.

FIG. 2 illustrates further aspects of an example RAG-generated content evaluation system 200. The RAG-generated content evaluation system 200 includes an evaluation metric generator 206 that generates metrics used by a RAG performance evaluator 208 to evaluate the quality (e.g., accuracy and completeness) of AI-generated answers to a set of test questions. By using the metrics to evaluate RAG-generated answers to the test questions, differently configured RAG systems can be objectively compared in terms of respective output content quality.

During a test preparation phase 229, the evaluation metric generator 206 is provided with a set of inputs referred to herein as “document-specific question-answer information 210.” The document-specific question-answer information 210 includes at least a set of test questions 216 that are derived from select documents in a source index 214 made available to a RAG system being tested (e.g., one of the RAG systems 234, 236, 238). For example, each one of the test questions 216 is derived from a corresponding data chunk (e.g., the document 220) residing in the source index 214. It is assumed that the data chunk used to derive each test question is usable to accurately and fully answer the test question without referencing any other document internal or external to the source index 214. Different questions in the set of test questions 212 may be derived from different data chunks in the source index 214.

In FIG. 2, the document-specific question-answer information 210 includes a set of “ground truth answers 218” that includes a single (correct) answer to each one of the test questions 216. In various implementations, the document-specific question-answer information 210 is derived differently. In one implementation, the test questions 216 and the ground truth answers 218 are manually prepared and provided to the RAG-generated content evaluation system 200 by an end user - e.g., the same user that has populated the source index 214, and that is utilizing the RAG-generated content evaluation system 200 to configure a RAG system to answer questions using the source index 214, as generally described with respect to FIG. 1.

In another implementation, the end user supplies the test questions 216, and an LLM 222 is employed to generate the ground truth answers 218. For example, the user generates the test questions 216 and also provides the RAG-generated content evaluation system 200 with an identification of a select data chunk from the source index 214 that can be used to answer each of the test questions 216. For example, LLM 222 is prompted to answer each of the test questions 216 exclusively using the associated user-identified data chunk, and the LLM returns a corresponding ground truth answer for each of the test questions 216.

In another implementation, the LLM 222 generates both the test questions 216 and the ground truth answers 218. For example, the LLM 222 is explicitly prompted to generate one or more question-answer pairs using designed or randomly selected data chunks from the source index 214. This implementation is discussed in greater detail with respect to FIG. 3.

The evaluation metric generator 206 uses the document-specific question-answer information 210 to generate a question-specific evaluation metric 224 for each of the test questions 212—that is, a different metric is generated for each of the test questions and used to quantify the quality of AI-generated answer(s) to the corresponding test question. To generate the question-specific evaluation metric 224 for a given test question, the evaluation metric generator 206 provides the LLM 222 with an instruction represented in FIG. 2 as “answer-analysis prompt 226.”

In one implementation, the answer-analysis prompt 226 includes a select one of the test questions, the corresponding ground truth answer, and a directive to generate conditional statements referred to herein as “answer construct conditions 228” that describe what is (or what is not) included in the associated ground truth answer. For example, the directive instructs the LLM 222 to analyze the ground truth answer to the specified test question, identify the components of the ground truth answer, and return assertive statements (e.g., the answer construct conditions 228) that each identifies one of the components of the corresponding ground truth answer. In the implementation of FIG. 2, the LLM 222 is prompted to return each identified component of the ground truth answer in terms of a conditional statement. This conditional statement, referred to herein as an answer construct condition, can be an inclusive condition (e.g., “the response must mention [x]”) or an exclusive condition (e.g., “the response should not describe [y]”). In this way, each of the answer construct conditions 228 for a given test question identifies a condition that is satisfied by the ground truth answer to the test question.

The answer construct conditions 228 for a given test question are provided back to the evaluation metric generator 206 and used to generate the corresponding question-specific evaluation metric 224, which refers to a metric usable to evaluate the quality of other AI-generated answers to the same test question. In one implementation, the question-specific evaluation metric 224 includes terms that correspond to the answer construct conditions 228 for the associated test question. Each of the terms is numerically computed based on whether or not the answer being evaluated satisfies the corresponding one of the answer construct conditions 228.

Assume, for instance, that the LLM 222 evaluates the ground truth answer to a first test question and returns three answer construct conditions: (1) “the response must mention [x]”; (2) “the response must describe the difference between [a] and [b]”; and (3) “The response must be at least four sentences long. ” In a simple implementation of the above-described technology, the question-specific evaluation metric 224 includes three terms, each corresponding to one of the three answer construct conditions. In one implementation, each of the three terms includes a multiplier to be replaced with a 1 or 0 value, depending on whether the ground truth answer being evaluated satisfies the corresponding answer construct condition. When the question-specific evaluation metric 224 is subsequently evaluated to assess the quality of an AI-generated answer to the first test question, the AI-generated answers are parsed to identify which of the relevant answer construct conditions are satisfied. If, in the above example, all three terms are given equal weight, evaluation of the question-specific evaluation metric 224 for the first question yields a quality score that ranges range from 0 (if none of the answer construct conditions are satisfied by the first answer) to 3 (if all three of the answer construct conditions are satisfied by the first answer).

In some implementations, weights are determined and assigned to the answer construct conditions 228. For example, the evaluation metric generator 206 may include a user interface 240 that allows the user to input and/or preview the test questions 216 and ground truth answers 218 and further allows the user to input weights indicating the relative importance of the system-identified answer construct conditions 228 for some or all of the test questions 216. In this scenario, the user-provided weights are utilized as multipliers when calculating each term in the question-specific evaluation metric 224 for a given question

Following the test preparation phase 229, a testing phase 230 commences. During the testing phase 230, the RAG performance evaluator 208 is provided with the test questions 216 and the set of question-specific evaluation metrics derived for the test questions (e.g., with a different instance of the question-specific evaluation metric derived for each test question, as generally described above). The RAG performance evaluator 208 then queries the RAG systems 234, 236, and 238 with the test questions uses the corresponding question-specific evaluation metrics to evaluate (score) the RAG responses to each of the test questions, thereby deriving comparative quality data 250 that identifies which of the different RAG systems 234, 236, and 238 provided the highest-quality (most accurate and complete) answers to each test question and/or overall across the full set of the test questions 216.

In FIG. 2, the RAG systems 234, 236, and 238 are all configured to access the source index 214 but operate according to different sets of user-configurable parameters referred to herein as “RAG configuration parameters.” Thus, the RAG systems 234, 236, and 238 may represent the same system at different points in time (e.g., a system that is tested, reconfigured, and tested again) or multiple different RAG systems that may execute in parallel.

Examples of “RAG configuration parameters” include input parameters of the RAG assistant, input parameters of the corresponding LLM, and the identity of the LLM (e.g., model type and version) employed. For example, input parameters of the RAG assistant include the number of data chunks (e.g., source documents or portions thereof) that are selected for inclusion in each LLM prompt and a relevance “threshold” that governs whether or not a given data chunk is selected based on its determined degree of similarity to an input question and/or user conversation history. Examples of LLM model parameters include weights, biases, learning rate, activation functions, kernel size, and more. Examples of large language model types include, without limitation, the generative trained transformer (GPT) model, an Open Pretrained Transformer (OPT) model, a Bioscience Large Open-science Open-access Multilingual (BLOOM) model), a Bidirectional Encoder Representations from Transformers (BERT) model), etc.

Each of the different RAG systems 234, 236, and 238 is shown to include a RAG assistant 241, 242, 244 that communicates context-enhanced queries to a corresponding LLM 246, 248, and 251 to provide the functionality generally described with respect to FIG. 1. Although the LLMs 246, 248, 251 are referenced with different numerical identifiers in FIG. 2, it is understood that two or more of the LLMs 246, 248, and 251 may be the same model type and version (and potentially the same model instance) and/or different model types or versions.

By example, FIG. 2 illustrates a first test question 232 being passed to the RAG performance evaluator 208 along with the question-specific evaluation metric 224, which was pre-defined for the first test question. The first test question 232 is input to each of the differently-configured RAG systems 234, 236, and 238 and the corresponding RAG responses (e.g., answers 252, 254, and 258) received from each of the RAG systems 234, 236, and 238, respectively, are received at the RAG performance evaluator 208 and independently scored using the question-specific evaluation metric 224. This process is repeated for each of the test questions 216. In some implementations, the different RAG systems 234, 236, and 238 are tested sequentially. For example, all test questions 216 are asked of one of the RAG system 234, and the responses from this RAG system are observed and/or scored before the system is reconfigured (thereby yielding another one of the RAG systems 236 or 238), which is then subjected to the same testing, etc.

Following the evaluation of the test questions 216 described above, the evaluated metrics (scores) are used to generate the comparative quality data 250. In one implementation, the comparative quality data 250 is presented in a user interface 240 rendered on a user display (not shown). In some implementations, the comparative quality data 250 includes graphics and/or text depicting how each of the RAG systems 234, 236, and 238 performed, e.g., with respect to correctly and completely answering each test question - either individually, such as by presenting RAG-generated responses to some or all of the test questions 216 along with question-specific quality scores, and/or overall, such as by presenting a numerical value or graphical representation generated based on an aggregated of the question-specific quality scores generated by each different one of the tested RAG configurations. In some implementations, generating the comparative quality data 250 entails aggregating, summarizing, filtering, or otherwise transforming the individual scores resulting from the evaluation of the question-specific quality metrics to render the results to the end user in an easy-to-decipher manner.

FIG. 3 illustrates additional aspects of an example RAG-generated content evaluation system 300. The RAG-generated content evaluation system 300 includes a Q&A generator 308 that automatically generates test questions and ground truth answers that provide the foundation of the quality evaluation test described above with respect to FIG. 2.

During a configuration step, a user (not shown) provides the Q&A generator 308 with access to a source index (shown as RAG source index 314) of a RAG system that the user is testing and configuring. The RAG source index 314 includes multiple data chunks 302. Each of the data chunks includes either a contiguous portion of a source document (e.g., a full document or document excerpt) or content that is derived from a source document (e.g., via translation, summarization).

Per the example operations shown in FIG. 3, the Q&A generator 308 accesses the RAG source index 314, retrieves a select data chunk, and generates a Q&A generation prompt 312 that includes the select data chunk and that instructs the LLM 316 to derive a question-answer pair from the select data chunk. In response, the LLM 316 returns a question-answer pair 318, including a test question and a corresponding ground truth answer, both of which are derived from the select data chunk included in the Q&A generation prompt 312. This process is repeated multiple times, using different data chunks from the RAG source index 314, to generate a set of document-specific question-answer pairs 318 that each include a test question and corresponding ground truth answer.

Per the above-described methodology, the ground truth answer to each test question is guaranteed to be highly accurate because the LLM 316 is provided with the actual corresponding source data chunk and is explicitly instructed to use only that source data chunk to generate the question and corresponding answer. In contrast to this, a RAG system asked to answer the same test question is likely to output an answer that is less accurate than the above-described ground truth answer because the RAG assistant has to search for data chunks that appear relevant to user-submitted conversation data and provide those data chunk(s) to the LLM 316. The RAG assistant is not always guaranteed to provide the LLM 316 with the correct data chunk needed to answer a user question and, even in scenarios where the LLM 316 does receive the correct data chunk, the LLM 316 is typically provided with multiple other data chunks as well, which can create “noise” that dilutes the quality of the LLM-generated answer to the test question. Thus, each of the ground truth answers included in the document-specific question-answer pairs 318 is an accurate answer to the corresponding test question and can be used to derive a question-specific evaluation metric 320 (e.g., a scoring rubric) that can be used to objectively evaluate answers generated by RAG system(s) to the corresponding test question.

The document-specific question-answer pairs 318 are provided as input to an evaluation metric generator 306 that performs the same or similar operations as the evaluation metric generator described with respect to FIG. 2. For each one of the document-specific question-answer pairs 318, the evaluation metric generator 306 transmits an answer analysis prompt 322 to the LLM 316. The answer analysis prompt 322 includes the ground truth answer for the corresponding one of the document-specific question-answer pairs and instructs the LLM 316 to generate answer construct conditions 324 from the ground truth answer. Each set of the answer construct conditions 324 is used to derive a question-specific evaluation metric for the corresponding test question. The above-described process is repeated for each test question, thereby generating a different question-specific evaluation metric for each test question that is derived from the corresponding ground truth answer.

For example, FIG. 3 illustrates a first Q&A pair 326 including a test question, “Tell me about Azure OpenAI in two sentences.” The ground truth answer to this test question reads: “Azure OpenAI services provide REST API access to OpenAI's powerful language models, including the GPT-3, Codex, and Embeddings model series. Users can access the service through REST APIs, Python SDK, or our web-based interface in the Azure OpenAI Studio. ” In response to the answer analysis prompt 322, the LLM 316 has generated four answer construct conditions 324, including (1) “The response should mention Azure OpenAI”; (2) “The response should mention that Azure OpenAI Service provides REST API access to language models such as GPT-3, Codex, and Embeddings model series; ” and (3) The response should include precisely two sentences.

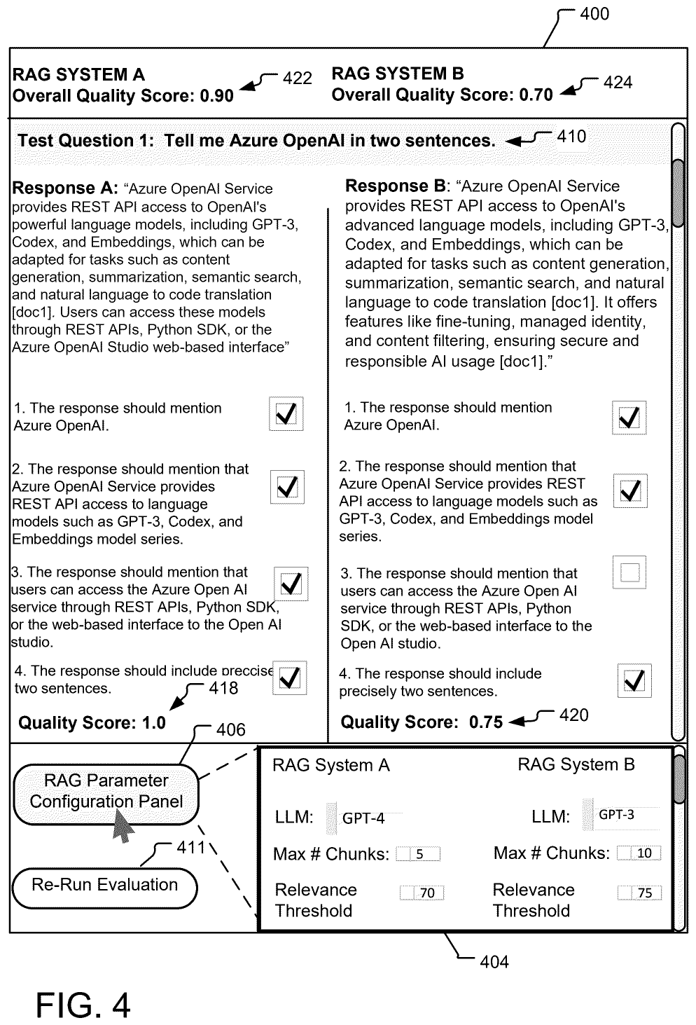

FIG. 4 illustrates an example user interface (UI) 400 presented by a RAG-generated content evaluation system implementing the herein-disclosed technology. In one implementation, the UI 400 is presented by the RAG performance evaluator 208, which operates within a system architecture the same or similar to that shown in FIG. 2. The UI 400 presents comparative quality data about two RAG systems—RAG system A and RAG system B—each of which is prompted to answer the same set of test questions. The two RAG systems are configured to use the same source index and to answer each query. The two RAG systems are configured according to at least one different RAG configuration parameter. A key objective of the RAG-generated content evaluation system is to help the user understand how the different RAG configuration parameters impact the quality of the RAG-generated responses.

Although the user can scroll to review how the two RAG systems answered each test question, the portion of the UI shown in FIG. 4 illustrates the first test question 410, which reads, “Tell me about Azure OpenAI in two sentences. ” The comparative quality data shown in the UI 400 identifies a first test question 410 passed as input to each of the corresponding RAG systems during the quality evaluation. The comparative quality data further identifies the responses (Response A and Response B) generated by RAG System A and RAG System B in response to the first test question.

Additionally, the comparative quality data in the UI 400 identifies a set of answer construct conditions (e.g., numbered 1-4 in each column) that were previously identified for the first test question 410 from a corresponding ground truth, per the same general methodology discussed with respect to FIG. 2 and FIG. 3 (e.g., the ground truth answer shown within the Q&A pair 326 of FIG. 3).

The comparative quality data 402 further indicates which of the answer construct conditions is satisfied by Response A and which is satisfied by Response B. In this example, Response A satisfies all of the answer construct conditions. However, Response B satisfies three out of four of the answer construct conditions because it fails to mention that “users can access the Azure Open AI service through REST APIs, Python SDK, or the web-based interface to the Open AI studio” (answer construct condition #3). This information is used to compute a quality metric (not shown) for the first test question 410, resulting in a first quality score 418 for Response A and a second quality score 420 for Response B. In this case, Response B has received a lower quality score than Response B because Response B satisfies three out of four of the answer construct conditions, while Response A satisfies all four.

Although not visible on the portion of the UI 400 shown in FIG. 4, the above-described types of comparative quality data 402 may also be presented for other test questions asked of the two RAG systems. For example, the same information may be presented with respect to all of the test questions or for a subset of the questions, such as a subset of the test questions representative of performance differences between the two systems. For example, the RAG performance evaluator may selectively present the above-described comparative quality data for the subset of the test questions with corresponding quality scores for RAG System A and RAG system B that differ by at least a threshold.

In addition to the above-described information, the comparative quality data 402 includes an overall response quality score for each tested RAG system (e.g., overall response quality scores 422 and 424). The overall quality score of each RAG system is derved from the quality scores computed with respect to the test questions asked of two RAG systems. The overall score is indicative of the overall performance of each RAG system and helps the user to quickly identify the highest-performing RAG system.

A left region of the UI 400 includes a RAG parameter configuration panel button 406 and a re-run evaluation button 411. When the user selects a RAG parameter configuration panel button 406, the user is presented with a RAG configuration panel 404 that presents various interactive configuration options. In the illustrated example, the RAG configuration panel 404 includes an option that allows the user to designate the type of LLM model with which the RAG systems interact. Here, the user has designated “GPT-4” as the select LLM for RAG system A and designed “GPT-3”as the select LLM for RAG system B.

In FIG. 4, the interactive RAG configuration panel 404 also includes a UI element that allows the user to specify the maximum number of data chunks from the source index that the corresponding RAG assistant can include in each context-enhanced LLM prompt. Additionally, the RAG configuration panel 404 include sa UI element that allows the user to set a “relevance threshold” that governs how similar the embedding of a given data chunk must be to a conversation embedding (e.g., encoding the user query and optionally, a selection of earlier RAG system inputs/outputs during the same conversation) to be included in a context-enhanced LLM prompt.

Notably, the RAG system responses to the test questions (e.g., Response A and Response B) may embed citations to the source data chunks used to derive various components of each answer. For example, both Response A and Response B include citations to “doc1.” This citation information helps the user understand which references are and are not being found by each RAG system when answering the set of test questions. Altering the “max number of data chunks” or “relevance threshold” parameters may impact how often each RAG system is able to find the best (most correct) reference(s) to answer each test question. Thus, the user may observe that when these parameters are altered, citations to some references appear or disappear. Although not shown in the UI 400, the RAG configuration panel 404 may additionally or alternatively include options that allow the user to configure countless other parameters of the RAG assistant and the backend LLM.

After selectively reconfiguring one or more of the interactive configuration options 404, the user can select the re-run evaluation button 411 to re-execute the quality evaluation by prompting the RAG system(s) (with one or more updated RAG configuration parameters) to answer the same set of test questions. The responses are then re-assessed to re-generate the above-described comparative quality data, which is refreshed on the UI 400. In this way, the end user can interactively tune RAG configuration parameters and observe how each change affects the quality of system outputs. This allows the user to easily identify the most optimal configuration for their RAG setup (e.g., given the types of source documents and test questions generated from them).

In at least one implementation, the RAG performance generator automatically selects different sets of RAG configuration parameters to test, identifies a collection of the RAG configuration parameters that yield the highest-quality output with respect to the test questions (based on evaluation of the herein-described question-specific evaluation metrics), and recommends that the end user configure their system to match that collection of RAG configuration parameters. The end user can then optionally adopt the recommended configuration parameters in the RAG system that they are configuring.

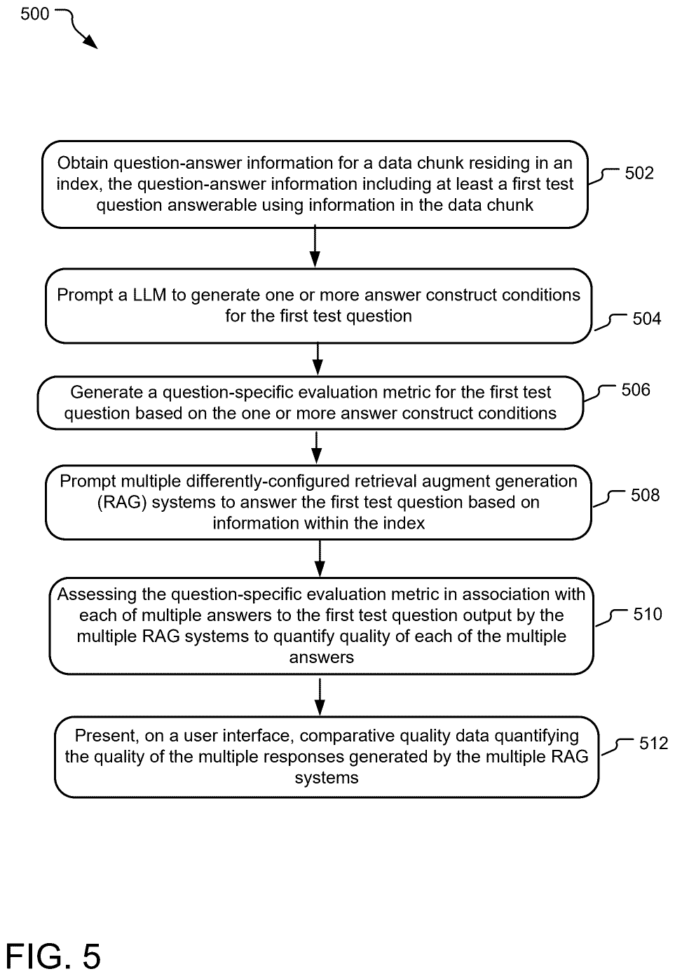

FIG. 5 illustrates example operations 500 for conducting an objective quality assessment of content output by multiple, differently configured RAG systems. A first evaluation preparation operation 502 obtains question-answer information for one or more data chunks residing in an index that is made accessible to each of the differently configured RAG systems being evaluated per the operations 500. The question-answer information includes at least a first test question that can be answered from information included in the data chunk that the first test question is derived from. In one implementation, the question-answer information additionally includes a ground truth answer to the first test question that is derived from the same data chunk as the first test question.

A second evaluation preparation operation 504 prompts an LLM to generate one or more answer construct conditions for the first test question. Each of the one or more answer construct conditions identifies a condition satisfied by a ground truth answer to the first test question. A third evaluation preparation operation 506 generates a question-specific evaluation metric for the first test question based on the one or more answer construct conditions.

Following the third evaluation preparation operation 506, a first evaluation operation 508 prompts multiple differently-configured RAG systems to answer the first question based on information residing in the source index. A second evaluation operation 510 assesses the question-specific evaluation metric in association with each of multiple answers to the first test question output by the multiple RAG systems to quantify the quality of each of the multiple answers compared to the ground truth answer to the first test question. In one implementation, assessing the question-specific evaluation metric includes computing a value for the question-specific evaluation metric in association with each of the multiple answers, with the value being representative of the quality of that answer. A presenting operation 512 presents comparative quality data on a user interface. The comparative quality data quantifies the quality of the response generated by the multiple RAG systems relative to one another and to the ground truth answer and is derived based on the assessment of the quality-specific evaluation metric for the multiple answers.

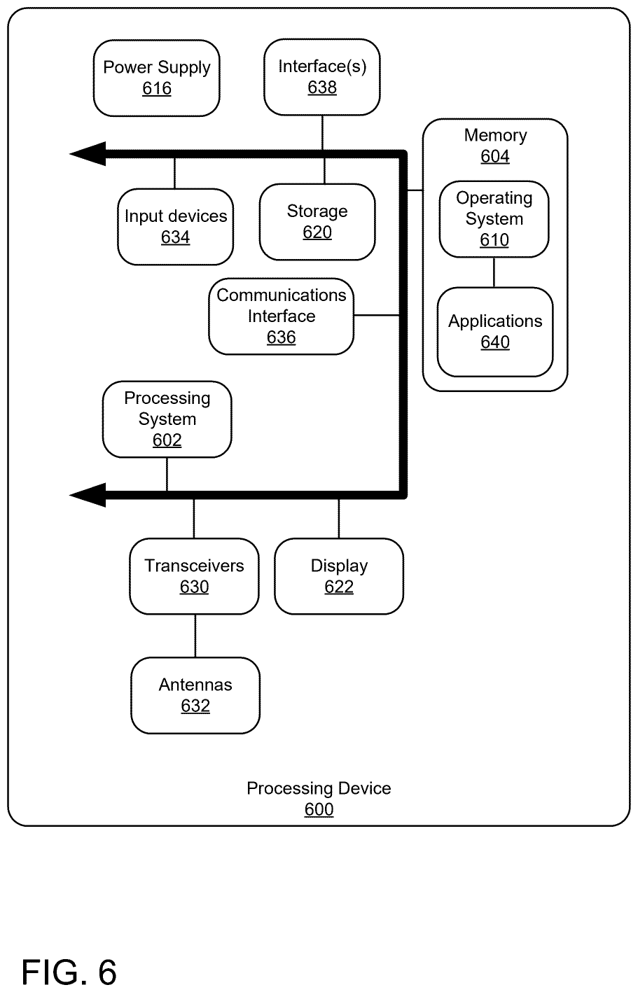

FIG. 6 illustrates an example computing device 600 for use in implementing the described technology. The computing device 600 may be a client computing device (such as a laptop computer, a desktop computer, or a tablet computer), a server/cloud computing device, any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 650.

In the example computing device 600, as shown in FIG. 6, one or more software modules, segments, and/or processors, such as applications 640, are loaded into the operating system 610 on the memory 604 and/or the storage 620 and executed by the processor(s) 602. The applications 640 may include aspects of a generative AI quality evaluation system, including a chatbot (e.g., web-based application), an LLM, a RAG assistant, an evaluation metric generator (e.g., evaluation metric generator 206 of FIG. 2), a question-answer generator (e.g., the Q&A generator 308 of FIG. 3), a RAG performance evaluator (e.g., the RAG performance evaluator 208 of FIG. 2), as well as various software-based subcomponents that may be including in the foregoing, such as a transformer, linear projection layers, position embedders, spectral layers, spectral processors, attention layers, attention processors, attention layers, attention networks, processing modules, classifier heads, layer normalizers, multi-layer perceptrons, multi-head self-attention layers, convolutional operators, spectral gating networks, embedding processors, output interfaces, and other program code and modules.

The storage 620 may store an input dataset, a dataset of identified features, embedding spaces, chunks, weights, and other data, and may be local to the computing device 600 or remote and communicatively connected to the computing device 600. In particular, in one implementation, components of a system for classifying a dataset may be implemented entirely in hardware or in a combination of hardware circuitry and software.

The computing device 600 includes a power supply 616, which may include or be connected to one or more batteries or other power sources and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a method including: obtaining question-answer information for a data chunk residing in a source index; prompting a large language model (LLM) to generate one or more answer construct conditions for a first test question included in the question-answer information, each of the one or more answer construct conditions identifying a condition that is satisfied by a ground truth answer to the first test question; generating a question-specific evaluation metric for the first test question based on the one or more answer construct conditions; prompting multiple retrieval augmented generation (RAG) systems to answer the first test question based on information within the source index, each of the multiple RAG systems being configured according to a different set of parameters; evaluating multiple responses to the first test question output by the multiple RAG systems by assessing the question-specific evaluation metric; and presenting, on a user interface, comparative quality data quantifying the quality of the multiple responses generated by the multiple RAG systems relative to one another.

In some aspects, the techniques described herein relate to a method, wherein the question-answer information includes a ground-truth answer to the first test question.

In some aspects, the techniques described herein relate to a method, wherein obtaining the question-answer information further includes prompting the LLM to generate question-answer pairs, each of the question-answer pairs including a test question and a corresponding ground truth answer derived from the data chunk.

In some aspects, the techniques described herein relate to a method, wherein using the question-specific evaluation metric to evaluate the quality of a response includes determining whether the response satisfies each of the one or more answer construct conditions.

In some aspects, the techniques described herein relate to a method, wherein the question-answer information includes multiple test questions answerable using information in the source index and wherein the method further includes: generating multiple question-specific evaluation metrics, each of the multiple question-specific evaluation metrics being usable to evaluate a quality of AI-generated responses to a different one of the multiple test questions; prompting each of the multiple RAG systems to answer the multiple test questions; evaluating the multiple question-specific evaluation metrics to generate response scores quantifying response quality for each of the multiple test questions answered by each of the multiple RAG systems; based on the response scores, generating an overall response quality score for each of the multiple RAG systems; and presenting on a user interface information indicating a highest-performing RAG system of the multiple RAG systems, the highest-performing RAG system being selected based on the overall response quality score.

In some aspects, the techniques described herein relate to a method, further including: presenting one or more user interface elements on the user interface, the one or more user interface elements being adapted to receive user input that alters a RAG configuration parameter within a RAG system, the RAG configuration parameter controlling at least one of: a maximum number of data chunks from the source index to be included in a context-enhanced LLM query generated by the RAG system; a relevance threshold that governs whether a data chunk in the source index is relevant enough to include in a context-enhanced LLM query generated by the RAG system; an identity of a backend LLM that receives and answers queries from the RAG system; and a LLM input parameter used by a RAG system when querying the backend LLM.

In some aspects, the techniques described herein relate to a method, wherein the method further includes: presenting on the user interface, a recommended RAG configuration, the recommended RAG configuration being automatically selected based on the comparative quality data.

In some aspects, the techniques described herein relate to a system including: an evaluation metric generator stored in memory and executable to: receive question-answer information for a data chunk residing in a source index, the question-answer information including at least a first test question answered by information in the data chunk; prompt a large language model (LLM) to generate one or more answer construct conditions for the first test question, each of the one or more answer construct conditions identifying a condition that is satisfied by a ground truth answer to the first test question; generate a question-specific evaluation metric for the first test question based on the one or more answer construct conditions; and a retrieval augmented generation (RAG) performance evaluator stored in memory and executable to: prompt multiple RAG systems to answer the first test question based on information within the source index, each of the multiple RAG systems being configured according to a different set of configurable parameters; quantifying quality of each of multiple responses to the first test question output by the multiple RAG systems by assessing the question-specific evaluation metric in association with each of the multiple answers; and present, on a user interface, comparative quality data quantifying the quality of the multiple responses generated by the multiple RAG systems relative to one another.

In some aspects, the techniques described herein relate to a system, wherein the question-answer information includes a ground-truth answer to the first test question.

In some aspects, the techniques described herein relate to a system, further including: a Q&A generator stored in memory and executable to: prompt the LLM to generate question-answer pairs, each of the question-answer pairs including a test question and a corresponding ground truth answer derived from the data chunk;

In some aspects, the techniques described herein relate to a system, wherein using the question-specific evaluation metric to evaluate quality of a select response includes determining whether the select response satisfies each of the one or more answer construct conditions.

In some aspects, the techniques described herein relate to a system, wherein the question-answer information includes multiple test questions answerable using information in the source index and wherein the evaluation metric generator is further executable to: generate multiple question-specific evaluation metrics, each of the multiple question-specific evaluation metrics being usable to evaluate a quality of AI-generated responses to a different one of the multiple test questions; prompt each of the multiple RAG systems to answer the multiple test questions; use the multiple question-specific evaluation metrics to generate response scores quantifying response quality for each of the multiple test questions answered by each of the multiple RAG systems; based on the response scores, generate an overall response quality score for each of the multiple RAG systems; and present on a user interface information indicating a highest-performing RAG system of the multiple RAG systems, the highest-performing RAG system being selected based on the overall response quality score.

In some aspects, the techniques described herein relate to a system, wherein the RAG performance evaluator is further configured to: present one or more user interface elements on the user interface, the one or more user interface elements being adapted to receive user input that alters a RAG configuration parameter within a RAG system, the RAG configuration parameter controlling at least one of: a maximum number of data chunks from the source index to be included in a context-enhanced LLM query generated by the RAG system; a relevance threshold that governs whether a data chunk in the source index is relevant enough to include in a context-enhanced LLM query generated by the RAG system; an identity of a backend LLM that receives and answers queries from the RAG system; and a LLM input parameter used by a RAG system when querying the backend LLM.

In some aspects, the techniques described herein relate to a system, wherein the RAG performance evaluator is further executable to: select a recommended RAG configuration based on the comparative quality data; and present, on the user interface, an indication of the recommended RAG configuration.

In some aspects, the techniques described herein relate to one or more tangible computer-readable storage media encoding computer-executable instructions for executing a computer process, the computer process including: prompting an LLM to generate question-answer pairs from data chunks in a source index, each of the question-answer pairs including a test question and a ground truth answer that are both derived from a select data chunk in the source index; prompting a large language model (LLM) to generate one or more answer construct conditions from the ground truth answer of each of the question-answer pairs, each of the one or more answer construct conditions identifying a condition that is satisfied by the corresponding ground truth answer; generating a question-specific evaluation metric for a first test question based on the one or more answer construct conditions derived from the ground truth answer to the first test question; conducting a response quality evaluation that entails: prompting multiple retrieval augmented generation (RAG) systems to answer the first test question based on information within the source index, each of the multiple RAG systems being configured according to a different set of user-configurable parameters; using the question-specific evaluation metric to quantify quality of each of multiple responses to the first test question output by the multiple RAG systems; and presenting, on a user interface, comparative quality data indicative of the quality of the multiple responses generated by the multiple RAG systems relative to one another.

In some aspects, the techniques described herein relate to one or more tangible computer-readable storage media, wherein using the question-specific evaluation metric to evaluate the quality of each of the multiple responses to the first test question includes determining whether each of the multiple responses satisfies the one or more answer construct conditions.

In some aspects, the techniques described herein relate to one or more tangible computer-readable storage media, wherein the computer process further includes: generating multiple question-specific evaluation metrics each corresponding to a different one of the question-answer pairs; prompting each of the multiple RAG systems to answer multiple test questions, each of the multiple test questions being included in a corresponding one of the question-answer pairs; evaluating the multiple question-specific evaluation metrics to generate response scores quantifying relative quality of responses generated by the multiple RAG systems to the multiple test questions; based on the response scores, generating an overall response quality score for each of the multiple RAG systems; and presenting on a user interface information indicating a highest-performing RAG system of the multiple RAG systems, the highest-performing RAG system being selected based on the overall response quality score.

In some aspects, the techniques described herein relate to one or more tangible computer-readable storage media, wherein the computer process further includes: presenting one or more interactive elements on the user interface, the one or more interactive elements being adapted to receive user input that alters a RAG configuration parameter within a RAG system selected from the multiple RAG systems, the RAG configuration parameter controlling at least one of: a maximum number of data chunks from the source index to be included in a context-enhanced LLM query generated by the RAG system; a relevance threshold that governs whether a data chunk in the source index is relevant enough to include in a context-enhanced LLM query generated by the RAG system; an identity of a backend LLM that receives and answers queries from the RAG system; and a LLM input parameter used by a RAG system when querying the backend LLM.

In some aspects, the techniques described herein relate to one or more tangible computer-readable storage media, wherein the computer process further includes: presenting on the user interface, a recommended RAG configuration, the recommended RAG configuration being automatically selected based on the comparative quality data.

In some aspects, the techniques described herein relate to one or more tangible computer-readable storage media, wherein the user interface includes: a first element selectable by a user to alter a RAG system parameter of one or more of the multiple RAG systems; and a second element selectable by a user to re-run the response quality evaluation based on the altered RAG system parameter. Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like.

The executable computer program instructions may be implemented according to a predefined computer language, manner, or syntax, to instruct a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method comprising:
obtaining question-answer information for a data chunk residing in a source index;
prompting a large language model (LLM) to generate one or more answer construct conditions for a first test question included in the question-answer information, each of the one or more answer construct conditions identifying a condition that is satisfied by a ground truth answer to the first test question;
generating a question-specific evaluation metric for the first test question based on the one or more answer construct conditions;
prompting multiple retrieval augmented generation (RAG) systems to answer the first test question based on information within the source index, each of the multiple RAG systems being configured according to a different set of parameters;
evaluating multiple responses to the first test question output by the multiple RAG systems by assessing the question-specific evaluation metric; and
presenting, on a user interface, comparative quality data quantifying the quality of the multiple responses generated by the multiple RAG systems relative to one another.

2. The method of claim 1, wherein the question-answer information includes a ground-truth answer to the first test question.

3. The method of claim 1, wherein obtaining the question-answer information further includes prompting the LLM to generate question-answer pairs, each of the question-answer pairs including a test question and a corresponding ground truth answer derived from the data chunk.

4. The method of claim 1, wherein using the question-specific evaluation metric to evaluate the quality of a response includes determining whether the response satisfies each of the one or more answer construct conditions.

5. The method of claim 1, wherein the question-answer information includes multiple test questions answerable using information in the source index and wherein the method further includes:
generating multiple question-specific evaluation metrics, each of the multiple question-specific evaluation metrics being usable to evaluate a quality of AI-generated responses to a different one of the multiple test questions;
prompting each of the multiple RAG systems to answer the multiple test questions;
evaluating the multiple question-specific evaluation metrics to generate response scores quantifying response quality for each of the multiple test questions answered by each of the multiple RAG systems;
based on the response scores, generating an overall response quality score for each of the multiple RAG systems; and
presenting on a user interface information indicating a highest-performing RAG system of the multiple RAG systems, the highest-performing RAG system being selected based on the overall response quality score.

6. The method of claim 1, further comprising:
presenting one or more user interface elements on the user interface, the one or more user interface elements being adapted to receive user input that alters a RAG configuration parameter within a RAG system, the RAG configuration parameter controlling at least one of:
a maximum number of data chunks from the source index to be included in a context-enhanced LLM query generated by the RAG system;
a relevance threshold that governs whether a data chunk in the source index is relevant enough to include in a context-enhanced LLM query generated by the RAG system;
an identity of a backend LLM that receives and answers queries from the RAG system; and
a LLM input parameter used by a RAG system when querying the backend LLM.

7. The method of claim 6, wherein the method further includes:
presenting on the user interface, a recommended RAG configuration, the recommended RAG configuration being automatically selected based on the comparative quality data.

8. A system comprising:
an evaluation metric generator stored in memory and executable to:
receive question-answer information for a data chunk residing in a source index, the question-answer information including at least a first test question answered by information in the data chunk;
prompt a large language model (LLM) to generate one or more answer construct conditions for the first test question, each of the one or more answer construct conditions identifying a condition that is satisfied by a ground truth answer to the first test question;
generate a question-specific evaluation metric for the first test question based on the one or more answer construct conditions; and
a retrieval augmented generation (RAG) performance evaluator stored in memory and executable to:
prompt multiple RAG systems to answer the first test question based on information within the source index, each of the multiple RAG systems being configured according to a different set of configurable parameters;
quantifying quality of each of multiple responses to the first test question output by the multiple RAG systems by assessing the question-specific evaluation metric in association with each of the multiple answers; and
present, on a user interface, comparative quality data quantifying the quality of the multiple responses generated by the multiple RAG systems relative to one another.

9. The system of claim 8, wherein the question-answer information includes a ground-truth answer to the first test question.

10. The system of claim 8, further comprising:
a Q&A generator stored in memory and executable to:
prompt the LLM to generate question-answer pairs, each of the question-answer pairs including a test question and a corresponding ground truth answer derived from the data chunk.

11. The system of claim 8, wherein using the question-specific evaluation metric to evaluate quality of a select response includes determining whether the select response satisfies each of the one or more answer construct conditions.

12. The system of claim 8, wherein the question-answer information includes multiple
test questions answerable using information in the source index and wherein the evaluation metric generator is further executable to:
generate multiple question-specific evaluation metrics, each of the multiple question-specific evaluation metrics being usable to evaluate a quality of AI-generated responses to a different one of the multiple test questions;
prompt each of the multiple RAG systems to answer the multiple test questions;
use the multiple question-specific evaluation metrics to generate response scores quantifying response quality for each of the multiple test questions answered by each of the multiple RAG systems;
based on the response scores, generate an overall response quality score for each of the multiple RAG systems; and
present on a user interface information indicating a highest-performing RAG system of the multiple RAG systems, the highest-performing RAG system being selected based on the overall response quality score.

13. The system of claim 8, wherein the RAG performance evaluator is further configured to:
present one or more user interface elements on the user interface, the one or more user interface elements being adapted to receive user input that alters a RAG configuration parameter within a RAG system, the RAG configuration parameter controlling at least one of:
a maximum number of data chunks from the source index to be included in a context-enhanced LLM query generated by the RAG system;
a relevance threshold that governs whether a data chunk in the source index is relevant enough to include in a context-enhanced LLM query generated by the RAG system;
an identity of a backend LLM that receives and answers queries from the RAG system; and
a LLM input parameter used by a RAG system when querying the backend LLM.

14. The system of claim 8, wherein the RAG performance evaluator is further executable to:
select a recommended RAG configuration based on the comparative quality data; and
present, on the user interface, an indication of the recommended RAG configuration.

15. One or more tangible computer-readable storage media encoding computer-executable instructions for executing a computer process, the computer process comprising:
prompting an LLM to generate question-answer pairs from data chunks in a source index, each of the question-answer pairs including a test question and a ground truth answer that are both derived from a select data chunk in the source index;
prompting a large language model (LLM) to generate one or more answer construct conditions from the ground truth answer of each of the question-answer pairs, each of the one or more answer construct conditions identifying a condition that is satisfied by the corresponding ground truth answer;
generating a question-specific evaluation metric for a first test question based on the one or more answer construct conditions derived from the ground truth answer to the first test question;
conducting a response quality evaluation that entails:
prompting multiple retrieval augmented generation (RAG) systems to answer the first test question based on information within the source index, each of the multiple RAG systems being configured according to a different set of user-configurable parameters;
using the question-specific evaluation metric to quantify quality of each of multiple responses to the first test question output by the multiple RAG systems; and
presenting, on a user interface, comparative quality data indicative of the quality of the multiple responses generated by the multiple RAG systems relative to one another.

16. The one or more tangible computer-readable storage media of claim 15, wherein using the question-specific evaluation metric to evaluate the quality of each of the multiple responses to the first test question includes determining whether each of the multiple responses satisfies the one or more answer construct conditions.

17. The one or more tangible computer-readable storage media of claim 15, wherein the computer process further comprises:
generating multiple question-specific evaluation metrics each corresponding to a different one of the question-answer pairs;
prompting each of the multiple RAG systems to answer multiple test questions, each of the multiple test questions being included in a corresponding one of the question-answer pairs;
evaluating the multiple question-specific evaluation metrics to generate response scores quantifying relative quality of responses generated by the multiple RAG systems to the multiple test questions;
based on the response scores, generating an overall response quality score for each of the multiple RAG systems; and
presenting on a user interface information indicating a highest-performing RAG system of the multiple RAG systems, the highest-performing RAG system being selected based on the overall response quality score.

18. The one or more tangible computer-readable storage media of claim 15, wherein the computer process further comprises:
presenting one or more interactive elements on the user interface, the one or more interactive elements being adapted to receive user input that alters a RAG configuration parameter within a RAG system selected from the multiple RAG systems, the RAG configuration parameter controlling at least one of:
a maximum number of data chunks from the source index to be included in a context-enhanced LLM query generated by the RAG system;
a relevance threshold that governs whether a data chunk in the source index is relevant enough to include in a context-enhanced LLM query generated by the RAG system;
an identity of a backend LLM that receives and answers queries from the RAG system; and
a LLM input parameter used by a RAG system when querying the backend LLM.

19. The one or more tangible computer-readable storage media of claim 15, wherein the computer process further comprises:
presenting on the user interface, a recommended RAG configuration, the recommended RAG configuration being automatically selected based on the comparative quality data.

20. The one or more tangible computer-readable storage media of claim 15, wherein the user interface includes:
a first element selectable by a user to alter a RAG system parameter of one or more of the multiple RAG systems; and
a second element selectable by a user to re-run the response quality evaluation based on the altered RAG system parameter.
